(19) United States
(12) Patent Application Publication
(10) Pub. No.: US 2011/0273100 A1
(43) Pub. Date: Nov. 10, 2011

(54) USER PROGRAMMABLE LIGHTING CONTROLLER SYSTEM AND METHOD

(75) Inventors: Thomas C. Sloan, Santa Barbara, CA (US); John Day, Santa Barbara, CA (US)

(73) Assignee: SloanLED, Inc.

(21) Appl. No.: 12/939,878

(22) Filed: Nov. 4, 2010

Related U.S. Application Data
(60) Provisional application No. 61/257,939, filed on Nov. 4, 2009.

(51) Int. Cl. H05B 37/02

(52) U.S. Cl. 315/192; 315/312; 315/185 R; 315/313

(57) ABSTRACT

Lighting systems wherein the lighting effects can be customized by the user to include different colors or different color changing effects. The lighting systems are arranged to be used with different emitters, including but not limited to solid state emitters such as light emitting diodes (LEDs), wherein the LEDs can be divided into zones. The lighting produced in each of those zones can be customized to be a unique color of light or to change colors in a particular way. The lighting system also allows for the different zones to be programmed to cooperate, such as allowing for particular colors of light to flow from one zone to another. Other lighting characteristics can also be controlled, including but not limited to color intensity, speed of color changing or the different colors included in the sequence of color changing.

This application claims the benefit of U.S. Provisional Patent Application Ser. No. 61/257,939, filed on Nov. 4, 2009, and having the same title as this application.

### BACKGROUND OF THE INVENTION

1. Field of the Invention

This invention relates to a system and method for controlling the illumination of multiple emitters, and in particular a user programmable lighting controller system and method for spas.

2. Description of the Related Art

Developments in light emitting diodes (“LEDs”) have resulted in devices that are brighter, more efficient and more reliable. LEDs are now being used in many applications that were previously the realm of incandescent bulbs; some of these include displays, automobile taillights, traffic signals and more recently architectural and landscape lighting, as well as pool and spa lighting. As the efficiency of LEDs improves it is expected that they will be used in most lighting applications.

Different controllers have been developed to drive multiple light sources. U.S. Pat. No. 4,962,687 to Belliveau et al. discloses a variable color lighting system which includes light fixtures controlled from a central processor unit which includes a plurality of control channels. Each light fixture includes a plurality of chromatic light sources, and the intensity of each chromatic light source is controlled in accordance with a program from the central processor over the control channels. Each light fixture is assigned a channel address, and responds only to a digital input packet from the central controller that can have the same address. The digital input packet controls how the light fixture changes color intensities.

U.S. Pat. No. 6,016,038 to Mueller et al. discloses a system with pulse width modulated current control for an LED lighting assembly, where each current-controlled unit is uniquely addressable and capable of receiving illumination color information on a computer lighting network. The invention can include a binary tree network configuration of lighting units (nodes) and can comprise a heat dissipating housing made out of a heat-conductive material, for a housing the lighting assembly. The heat dissipating housing contains two stacked circuit boards holding respectively the power module and the light module. The light module is adapted to be conveniently interchanged with other light modules having programmable current and hence maximum light intensity, ratings. (See also U.S. Pat. Nos. 6,150,774; 6,211,626 and 6,340,868).

U.S. Pat. No. 6,441,558 to Murtha discloses an LED luminary system for providing power to LED light sources to generate a desired light color which comprises a power supply stage configured to provide a DC current signal. A light mixing circuit is coupled to said power supply stage and includes a plurality of LED light sources with red, green and blue colors to produce various desired lights with desired color temperatures. A controller system is coupled to the power supply stage and is configured to provide control signals to the power supply stage so as to maintain the DC current signal at a desired level for maintaining the desired light output. The controller system is further configured to estimate lumen output fractions associated with the LED light sources based on junction temperature of the LED light sources and chromaticity coordinates of the desired light to be generated at the light mixing circuit. The light mixing circuit further comprises a temperature sensor for measuring the temperature associated with the LED light sources and a light detector for measuring lumen output level of light generated by the LED light sources. Based on the temperatures measured, the controller system determines the amount of output lumen that each of the LED light sources need to generate in order to achieve the desired mixed light output, and the light detector in conjunction with a feedback loop maintains the required lumen output for each of the LED light sources.

U.S. Pat. No. 6,930,452 to De Krijger et al. discloses a circuit arrangement for driving an LED array comprising red, green and blue LEDs, a control loop is added for limiting the duty cycles of the control signals for driving the red, green and blue LEDs. In case one of the duty cycles reaches the limit value, the reference signals for the red, green and blue light are decreased with the same relative amount. The color point of the light is thereby maintained, even when the efficiency of part of the LEDs decreases.

U.S. Pat. No. 7,258,463 to Sloan et al. (assigned to SloanLED, Inc. the same assignee herein) discloses a system for illuminating multiple LEDs comprising a controller programmed to provide a plurality of serial binary signals, each of which drives a respective one of the multiple LEDs. Each of the serial binary signals has a series of pulses with each of the plurality of LEDs emitting light during each pulse of its respective one of the serial binary signals. The emitting intensity of each of the plurality of LEDs depends on the number of pulses in its respective one of the serial binary signals, wherein the light from the plurality of LEDs combines to emit a color of light.

### SUMMARY OF THE INVENTION

The present invention is directed to lighting systems wherein the lighting effects can be customized by the user to include different colors or different color changing effects. The lighting systems according to the present invention can be used in many different applications, including but not limited to architectural or landscape lighting, with the embodiments below described in relation to pool/spa (“spa”) lighting applications.

The lighting systems are arranged to be used with different emitters, including but not limited to solid state emitters such as light emitting diodes (LEDs). In some embodiments, the LEDs can be divided into zones and the lighting produced in each of those zones can be customized to be a unique color of light or to change colors in a particular way. The lighting system also allows for the different zones to be programmed to cooperate, such as allowing for particular colors of light to flow from one zone to another. Other lighting characteristics can also be controlled, including but not limited to color intensity, speed of color changing or the different colors included in the sequence of color changing.

These and other features and advantages of the invention will be apparent to those skilled in the art from the following detailed description, taken together with the following drawings:

### BRIEF DESCRIPTION OF THE DRAWINGS

FIG. 1 is a block diagram of one embodiment of a lighting system according to the present invention;

FIG. 2 is a screen image for one embodiment of a graphical user interface according to the present invention;

FIG. 3 are additional screen images for one embodiment of a graphical user interface according to the present invention;

FIG. 4 s still another screen image for one embodiment of a graphical user interface according to the present invention;

FIG. 5 is one embodiment of a spa utilizing a spa lighting system according to the present invention; and

FIG. 6 is one embodiment of a method according to the present invention.

### DETAILED DESCRIPTION OF THE INVENTION

The present invention provides lighting control systems and methods for controlling lighting elements in different lighting applications, such as controlling lighting elements in a pool/spa (“spa”). Lighting control systems according to the present invention can comprise many different hardware and software components and in one embodiment comprises a controller and associated user interface that allows the user of a spa to customize the lighting effects of the spa by controlling certain lighting characteristics. These characteristics can include, but are not limited to the lighting sequence, colors and brightness of the lighting elements. The different elements can comprise flood lights, point lights or lighted spa components such as jets or drains, waterfalls or speakers.

In some embodiments, the lighting system operates by dividing the different spa lighting elements into zones, but is understood that in other embodiments individual lighting elements can be controlled or there can be a mixture of zones and individual elements. In one embodiment, the controller drives lighting elements in up to four zones each of which can be programmed separately to emit different colors or sequences of light, or can be programmed to work in sequence with each other to create numerous unique lighting effects.

The spa lighting control system is fully programmable by the spa user or spa manufacturer using a computer (such as a PC) and a communication port (USB) to transmit data to the spa controller. The software and hardware includes a graphical user interface where the different lighting functions and effects can be created. Different lighting zones can be created and programmed to emit light in different ways such as in sync or out of sync. In others colors can flow between zones, custom colors can be created, and custom color patterns can be created. In some embodiments the speed at which the color changes and the transition between colors, either smooth or abrupt, can also be programmed.

The controller hardware can be coupled to the lighting elements, such as LEDs, in many different ways, and in one embodiment the controller hardware can provide connectors coupled to multiple LEDs. In one embodiment, the multiple LEDs at each connector are connected in a daisy-chain, and within spa lighting elements each of these sets of daisy-chained LEDs can create one of the different lighting zones. In one spa embodiment, point light sources in the outside skirt of the spa may be one zone, while the main flood light is a second zone, the water features may be a third zone, and the spa speakers a fourth. This is only one example of the different zones and the respective zones that can be programmed differently, and in some embodiments orchestrated in coordination with each other, such as in color wheel or color jump modes. In one embodiment, the skirt lighting may be white, with main light being blue and the water features being red.

The present invention is described herein with reference to certain embodiments but it is understood that the invention can be embodied in many different forms with many different components, and should not be construed as limited to the embodiments set forth herein. The lighting systems can contain many different types of emitters that can be arranged in many different zones, and can comprise many different mechanisms for controlling the lighting effects produced by the zones.

It is also understood that when an element or component is referred to as being “connected to”, “coupled to”, or “in electrical contact with” another element, it can be directly connected to or coupled to the element, or directly in electrical contact with the element. It is understood however that intervening elements may also be present. It is also understood that an element or component referred to arranged to “accept” are as “accepting” a electrical voltage, current or signal, it can directly accept the voltage, current or signal, or can accept them through intervening elements.

The embodiments below are described with reference to systems having light emitting diodes (LEDs) and it is understood that many other lighting elements can also be used. In some embodiments the LEDs can comprise element capable of emitting red, green and blue light at different intensities. The elements are often referred to as RGB elements and each element can be driven to produce different colors of light depending on the relative intensities of red, green an blue light.

Although the terms first, second, etc. may be used herein to describe various elements, components, and/or sections, these elements, components, and/or sections should not be limited by these terms. These terms are only used to distinguish one element, component, or section from another element, component or section. Thus, a first element, component, or section discussed below could be termed a second element, component, or section without departing from the teachings of the present invention.

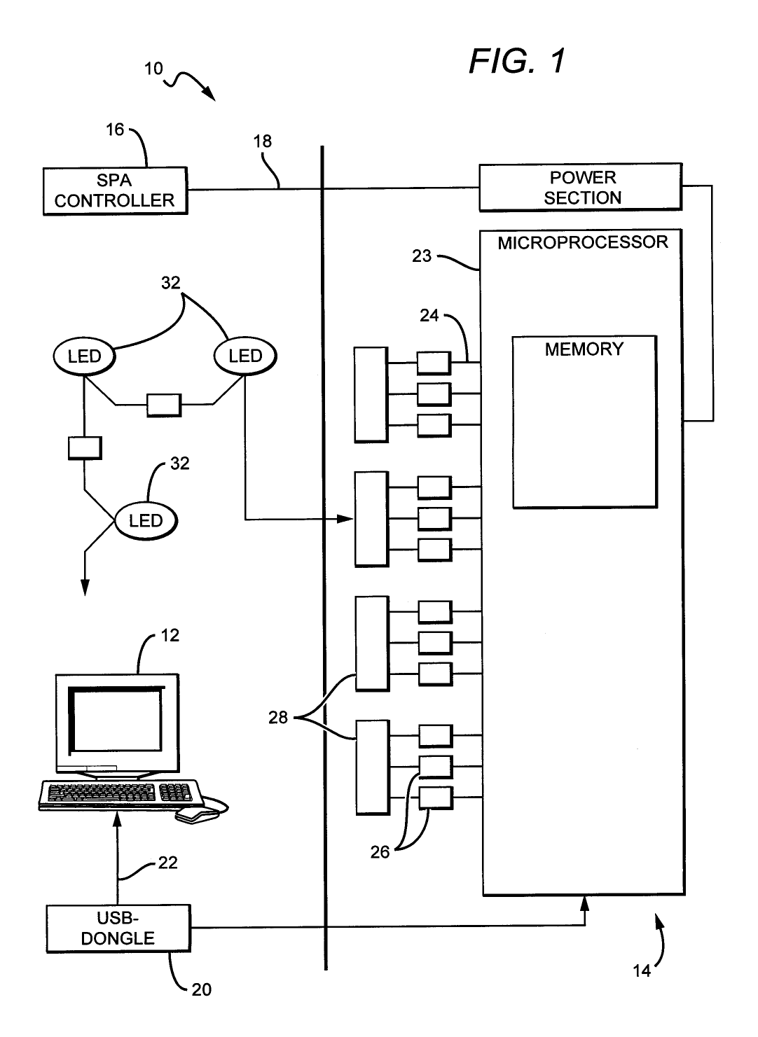

FIG. 1 shows one embodiment of a system 10 for controlling multiple lighting elements in different applications such as in spa lighting. The system 10 generally comprises a standard personal computer (PC) 12, controller hardware 14 and a power source 16. In this embodiment, the power source 16 comprises a standard spa controller, but it is understood that many different power sources can be used. The spa controller provides a 12 volt A/C signal and a switch signal, but many other power signals can be provided by power sources according to the present invention. The power source 16 can be coupled to the controller hardware 14 using one or more standard electrical conductors 18, such as a power cable and with standard connectors.

The PC 12 can comprise many different computers such as commercially available PCs operating with commercially available operating systems and application software. In one embodiment, the PC 12 can operate using commercially available Windows® based operating systems. In some embodiments the PC 12 can be directly connected to the controller hardware 14, while in other embodiments the PC 12 can be connected to the controller hardware 14 through other mechanism or devices. The controller hardware 14 can communicate with other devices that satisfy the controller hardware communication protocol. In the embodiment shown, the PC 12 is coupled to the controller hardware 14 through a USB-dongle 20, which are generally known in the art and not discussed in detail herein. The USB-Dongle carries the data to/from the controller hardware 14 and to/from the PC 12. The PC 12 can be connected to the controller hardware using one or more standard connection cables 22 that conduct electrical between the PC 12 to the controller hardware 14.

In the embodiment shown, the PC is connected to and communicates with the controller hardware 14 over a Universal Serial Bus (USB), although in other embodiments different busses can be used. A USB is a serial bus standard that is typically utilized to connect devices to a host computer or PC. USB was designed to allow many peripherals to be connected using a single standardized interface socket and to improve plug and play capabilities by allowing hot swapping; that is, by allowing devices to be connected and disconnected without rebooting the computer or turning off the device. Other convenient features include providing power to low-consumption devices, eliminating the need for an external power supply; and allowing many devices to be used without requiring manufacturer-specific device drivers to be installed.

In some embodiments, once the controller hardware is programmed by the PC 12 by communications through the USB-dongle 20, the controller hardware operates independent of the PC 12. In some embodiments the PC 12 can be disconnected from the hardware controller 14 following programming, while in other embodiments the PC can remain connected.

All functions of the hardware controller operate under control of a microprocessor 23, with the LED drive signals provided by the standard output pins 24 of the microprocessor. Different devices can be included at the output pins to amplify or otherwise condition the output signals from the output pins. In the embodiment shown, metal-oxide-semiconductor field-effect transistors (MOSFETs) 26 are included between the microprocessor output pins 24 and output connectors 28 to provide LED drive signals with high currents. The hardware controller can also have memory that is arranged in many different ways. In the embodiment shown, the microprocessor 23 has internal memory for holding data and programming information. It is understood, however, that in other embodiments memory external to the microprocessor can also be used.

In some embodiments of the hardware controller according to the present invention, two communication methods can be implemented on the one communication cable. One method is used for updating firmware (source code) and one to save the user created lighting effect data. In these embodiments, this communication can change firmware or the data in the microprocessor, but cannot operate the microprocessor. Stated differently, if the user changes firmware or the data, controller hardware operates different ways, but in these embodiments the PC cannot directly drive the microprocessor. It is understood that in other embodiments the PC and its communication can be arranged to drive the microprocessor. It is also understood that different software languages can be used for firmware programming, including but not limited to C/C++ languages.

Light emitting diodes (LEDs) 32 can directly connect on the controller hardware 14 at connectors 28, but it is understood that in other embodiments the LEDs can connect to the controller hardware through other devices. In some embodiments, the microprocessor can drive the LEDs in a zone arrangement. Each zone can be independently controlled by the microprocessor, or the different zones working together to produce different lighting effects. The number of zones can depend on the microprocessor's output pins and microprocessor's frequency. As discussed below, one of the operating modes for the system 10 is “Color Wheel”. If too many zones are used or if the frequency of the microprocessor 23 is too slow, the color changing of the Color Wheel mode may not be smooth. This is also true for other operating modes. In one embodiment, the hardware controller can operate at a 20 MHz frequency, and can have 4 zones. Each zone corresponds to one of the connectors with a respective set of LEDs 32 connected to each of the connectors 28.

In the embodiments shown, LEDs 32 at each of the connectors (i.e. each zone) are connected in series with the number of LEDs permitted in the string being largely dependent on the current and voltage level of the drive signals from the microprocessor 23 and the MOSFETs 26. It is understood, that in other embodiments the LED can be arranged in different serial/parallel interconnect structures, and the present invention should not be limited to serially connected LEDs. In one embodiment each zone can use 3 output pins from the microprocessor. A 20 MHz frequency and four zone arrangement allows for smooth color changing during the different operating modes. Many different microprocessors can be used, and depending on the number of output pins provided with the microprocessor different numbers of zones can be created. Different embodiments of controller hardware can function differently when powered down. In one embodiment, when the controller hardware is powered off, the mode it was on when it was powered off is the mode it will be on when it is powered on again.

Many different color effects can be created using the system 10, some of which include “Color Wheel”, “Color Jump”, “Color Extract” and “Color Flow”, all of which are described in more detail below. It is understood, however, that many other color effects can also be created using this zone arrangement.

In the Color Wheel mode the color produced by the LEDs very smoothly transfers between different colors by smoothly moving from one color to the next. In some embodiments, the different LED zones can have different themes for the color wheel, but they will all wheel (or change colors) in sync. The speed of the color changing can be controlled and in one embodiment four speed can be provided as slow, medium, medium-fast and fast. The Color Wheel can also be provided with different dimming levels, and in one embodiment three dimming levels as low-30%, Medium-60% and high 100%. In other embodiments transition between colors can be smooth or can be through intermediate colors. One such embodiment can go to black momentarily between the colors.

Different software arrangements can be utilized to product the Color Wheel mode and in one embodiment of a system 10 according to the present invention, the software uses an advanced look-up table method for the Color Wheel algorithm, and one such approach can utilize 2 of 9 step look-up tables. Using this approach, the two look-up tables and controller can re-create 81 steps of a table (9*9=81) and during transfer of the different colors, uses this 81 step of tables. This approach can provide the benefit of using less memory to implement the Color Wheel. Memory can be limited in most conventional microprocessors, so reducing memory usage and memory management can be important, particularly for 8-bit microprocessors.

In the Color Extract mode, different colors can be created for each of the zones. In one embodiment an algorithm can choose 81 color levels utilizing the Color Wheel's Advanced look-up table for each color element. Using this approach the Color Extract algorithms can theoretically create 531441 colors (81*81*81=531441) theoretically. In one embodiment of system 10 according to the present invention, practical limitations can be imposed such as allowing only 8 levels of each color element for a total of 512 color. This allows for easier set-up for each color and reduces the necessary software. Color can be created from a standard pallet such as white, cyan, magenta, blue, yellow, green, red, black.

The Color Jump mode is similar to the Color Wheel, but goes from one solid color to the next without fading between colors. Like the Color Wheel all four zones can have different themes for the Color Jumps and Color Jump can have four speeds such as slow, medium, medium-fast and flash. Color Jump can also have different dimming levels such as low-30%, medium-60% and high-100%, and transition between colors can go through black momentarily.

The Color Flow algorithm can stream color through any of zone to zone using Color Jump or Color Wheel. In this mode, color “flows” from one zone to the next through as many sequential zones as desired and this mode can be considered a subset of Color Wheel and Color Jump. Similar to above there are four color flow speeds including slow, medium, fast and flash. Color flow can also have different dimming levels such as low-30%, medium-60% and high 100%.

Pursuant to the present invention, the modes and zones can be customized by the user. The user can create the data (any colors, zones, patterns, methods) that the controller hardware 14 uses to drive the LEDs 32 to customize the coloring effects provided by the LEDs 32. In one embodiment the data is created at the PC using a graphical user interface (GUI). GUI's are generally known and are a type of user interface which allows people to interact with electronic devices such as computers. Conventional GUIs use a combination of technologies and devices to provide a platform that the user can interact with, for the tasks of gathering and producing information. The most common combination in GUIs is the WIMP (“window, icon, menu, pointing device) paradigm, especially in personal computers. This style of interaction uses a physical input device to control the position of a cursor and presents information organized in windows and represented with icons. Available commands are compiled together in menus and actioned through the pointing device. A window manager facilitates the interactions between windows, applications, and the windowing system. The windowing system handles hardware devices such as pointing devices and graphics hardware, as well as the positioning of the cursor. Different types of software can be used to create a GUI, and in one embodiment Java language can be used to create the GUI.

Using the GUI color effect data is created and is sent from the PC 12 to the controller hardware 14. This can be done under control of the user through the same GUI used to create the data. The ‘USB-dongle’ can be included between the PC and controller to assist in data transfer.

The color effect data is the content user's custom information that is created by utilizing the GUI. In one embodiment the algorithms and core programming (including the “Advanced look-up table”) can already be in the memory of the hardware controller 14. The core programming can include the hardware controller's communicate algorithms that can accept the color effect data and save onto the microprocessor's internal memory (e.g. EEPROM). After finishing the transfer of data and related communication, the SMZ controller operates itself with the data in memory. That is, once the data is transferred to memory, no other devices are needed to run the system. Controller hardware can run the modes discussed above including Color Wheel, Color Jump, Color Extract, Color Flow or other algorithms depending on the color effect data.

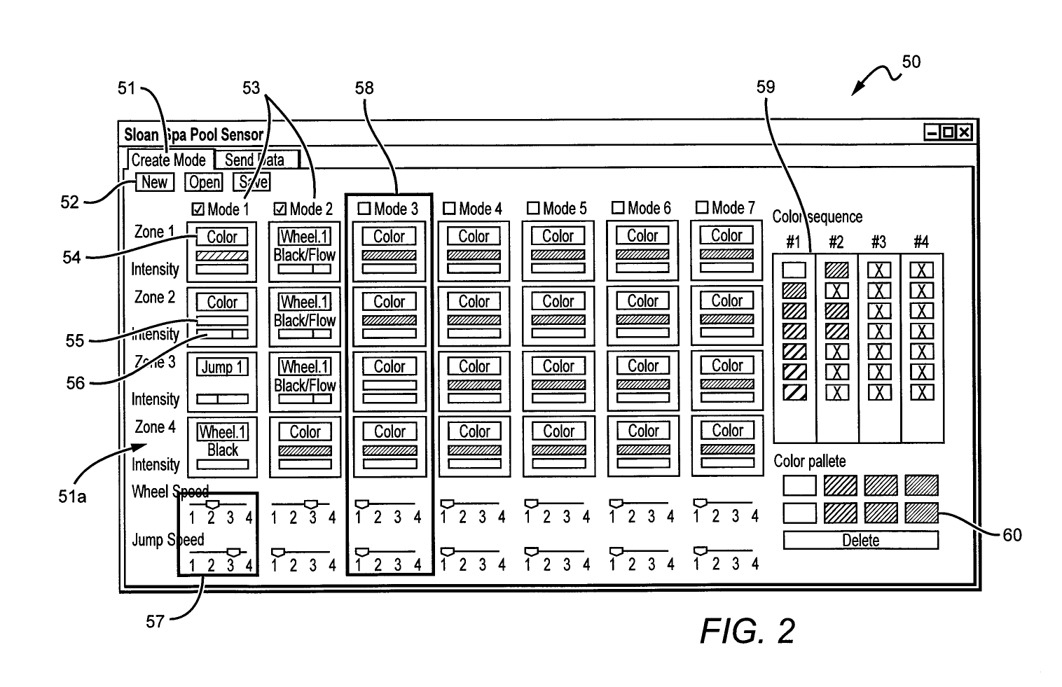

Many different GUIs can be used in different embodiments according to the present invention that can be programmed using known software and programming techniques. FIG. 2 shows a create screen image 50 from a PC for one embodiment of GUI interface according to the present invention. It is understood that the GUIs can take many different forms and can include multiple screen images, all of which can be used for gathering color effect data.

In the upper right hand corner the screen image has Color Mode and Send Data tabs. Activating the Create Mode 51 tab causes the create screen image 51a to be shown on the PC screen. Across the top of the page there are New, Open and Save buttons 52 that are used to open and save the color effect data created by the user.

The screen 50 provides seven columns each of which can be programmed to its own respective color effect. At the top of each column is a mode button 53, which is activated when that particular column is to be programmed with its color effect. When controller hardware accepts a switch signal, such as from the spa controller, the software can change from the current mode to the next mode. This can cause the controller to generate the different color effect of that particular mode. The user can select and program a single mode or can select and program up to seven modes. It is understood that different spa systems can be provided with fewer or more modes, some or all of which can be programmed at the user's discretion.

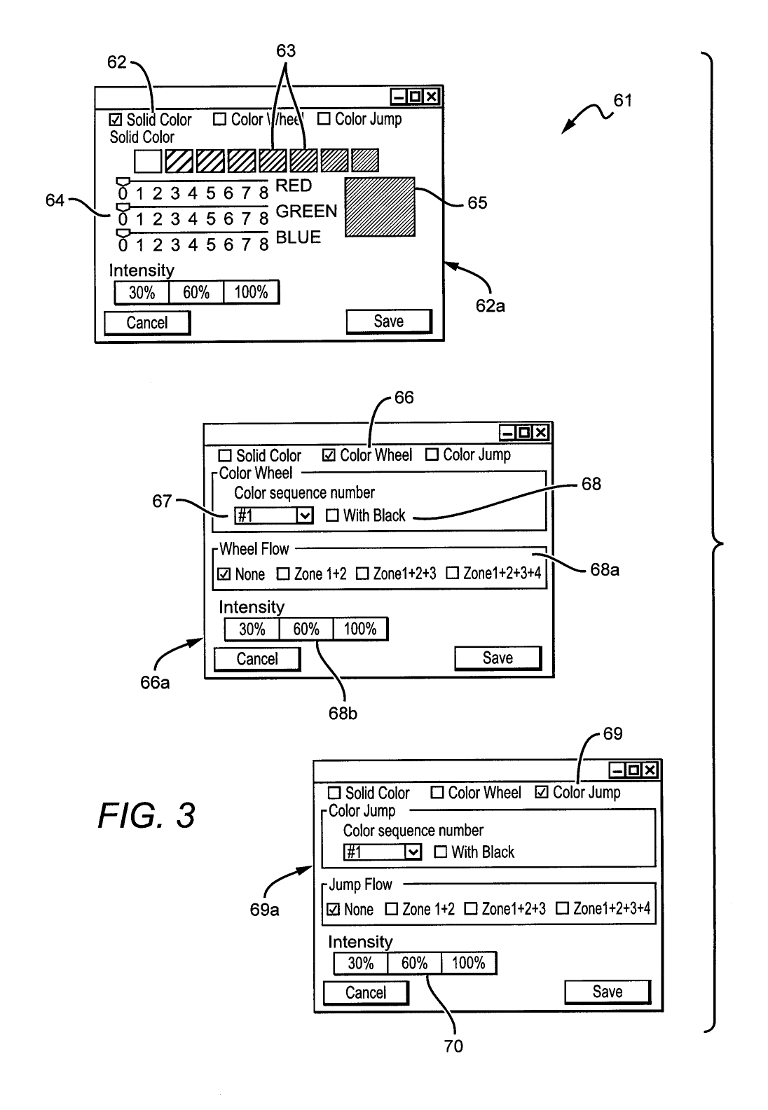

The first mode corresponds to the first column in screen 50 and each mode has four zones corresponding to the LED zones discussed above. Activating the zone 1 color button 54 causes the “Color State Set-up” windows shown in FIG. 3 to appear. After setup the Color state is complete as discussed below, the zone buttons display what color effect has been chosen in the Color State Set-up windows. Each zone can have its own color effect and in the embodiment shown zones 1 and 2 have been chosen to have a single color, while zone 3 has the color jump mode and zone 4 has the color wheel mode. Each zone has its own color state information display 55 which shows the custom color at the Color Extract algorithms. For zones 1 and 2 the solid color to be displayed is shown. For Color Wheel, Color Jump algorithms the custom information can be displayed such as black or black/flow. Intensity display 56 shows the intensity chosen for each of the zones in the Color State Set-up windows. Scale 57 allows for the speed of the color changing to be controlled in the Color Wheel or Color Jump with the speed of changing from slower to faster by using the curser to move the indicator along the scale 57.

The second mode is shown by box 58 and if this mode is selected, the controller hardware changes from mode 1 to mode 2 in response to the switch signal. Mode 2 is also programmed with its own color effects that the LED will emit in the different zones when operating Mode 2. If a particular one or more of the Modes 1-7 is not activated and the zones have not been set-up the default is to have all the LED in the OFF state. In box 59 different color sequences can be created for the Color Wheel and Color Jump effects using Color palette 60. By way of example sequence number 1 shows the seven different colors that the LEDs emit in succession during Color Wheel or Color Jump. In case of sequence 2, only 4 of the steps, yellow, off, green and magenta are activated. In one embodiment, that spa system software automatically deletes the last 3 of undefined box, but the second undefined box activate with LED Off because it is between two chosen colors.

FIG. 3 shows the “Color State Set-up” windows 61 which can be displayed when any of the ‘color’ buttons 1 shown on the main windows of FIG. 1 are activated. When the ‘Solid Color’ option 62 is chosen the solid color window 62a is displayed. Buttons 63 allow for the choosing of one of 8 colors, and the chosen color is diplayed on at box 65. Alternatively, a custom color can be created using the three color level bar 64, with the bars corresponding to red, green and blue light, and the bars allowing for different intensities of these three colors. These colors at different intensities then combine to produce a custom color of light that is displayed on box 65. When selected and saved, the particular zone that is chosen at the main menu will display the color chosen at 65.

When the ‘Color Wheel’ option is chosen at 66 the window 66a is displayed. Button 67 allows the user to choose between one of the four color sequences created in the main menu as discussed above. Using 68 the LEDs can be turned off between the ‘Color Sequence’ elements by displaying black between the elements. Using 68a a color flow can be activated between the different zones and in some embodiments Color Wheel and Color Jump, the single zone 1 is displayed. The color sequence can then be controlled to flow between 2, 3 or 4 zones. The intensity of the colors in the color wheel can also be controlled using the three intensity buttons 68b at the bottom of window 66a. Once the particular color wheel options are selected and saved, the zone on the main page operates with those characteristics.

When “Color Jump” 69 is selected, window 69a appears, which is similar to Color Wheel window. It allows for the selection of one of the color sequences from the main menu and allows for the option of having the LED off between colors if desired. The number of zones for flow can also be chosen and the intensity of light of the different colors in the color jump can be chose at the three light intensity buttons 70. When the desired options are chosen and saved, the corresponding zone in the main menu functions with these characteristics.

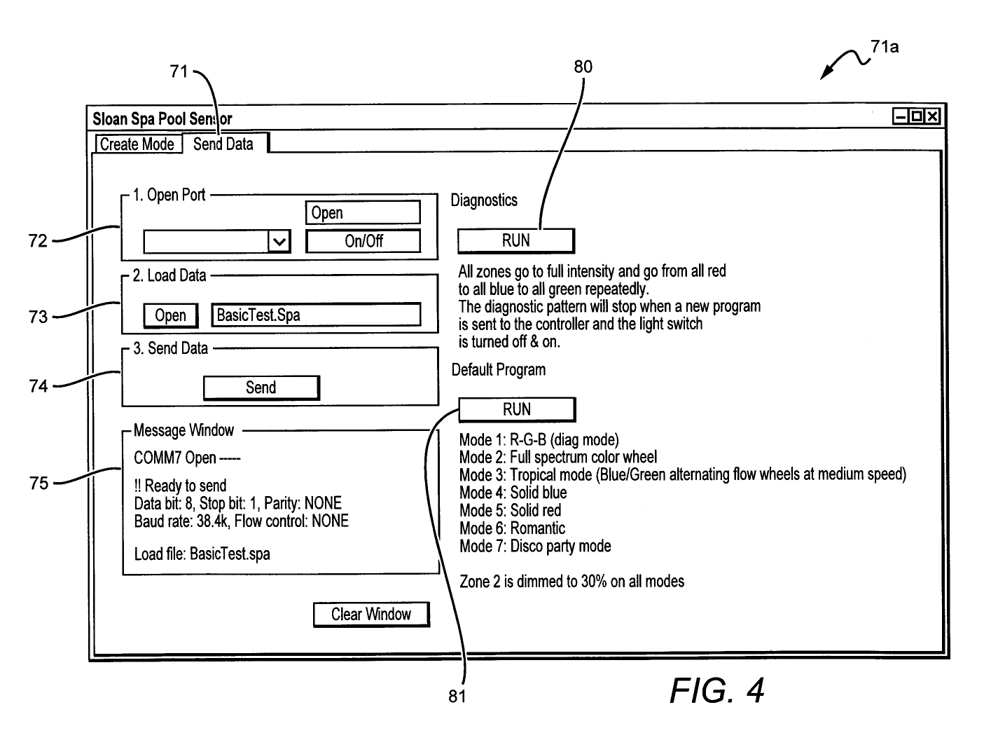

When the modes and zone options are selected and the desired color effect data is complete it is sent from the PC to the controller hardware memory. Referring now to FIG. 4, this can be accomplished by activating the Send Data tab 71 on the main page to display Send Data page 71a. The communication port with the controller hardware can opened or closed using the On/Off button at the Open Port 72. In one embodiment according to the present invention, the virtual COM port is used for communicating with controller hardware. Under Load Data section 73, data saved when creating the different mode and zone effects can be loaded by activating the Open button to open the particular file. Under the Send Data section 74 the loaded data can be sent to the hardware controller by activating the send button. The message window 75 display the information sent and in what order.

The Send Data page 71a also allows for the running of a diagnostics program by activating the diagnostic Run button 80. The diagnostics program verifies that that controller hardware (and software) is operating correctly. During the one embodiment of a diagnostic program all zones cycle through red, blue and green at full brightness. The diagnostic cycle continues until operator turns it off. Confirmation of correct LED operation is visual. After diagnostics program is ended the actual program with custom effects can be transferred to the microprocessor in the controller hardware. Validation of successful transfer can be sent to the computer.

The Send Data page 71a also allows for running of a manufacture default program by activating the run button 81 under the default program section. The effects for the one embodiment of the different zones are listed under this section, with the hardware controller switching between these modes in response to switch signals, such as those provided by the spa controller.

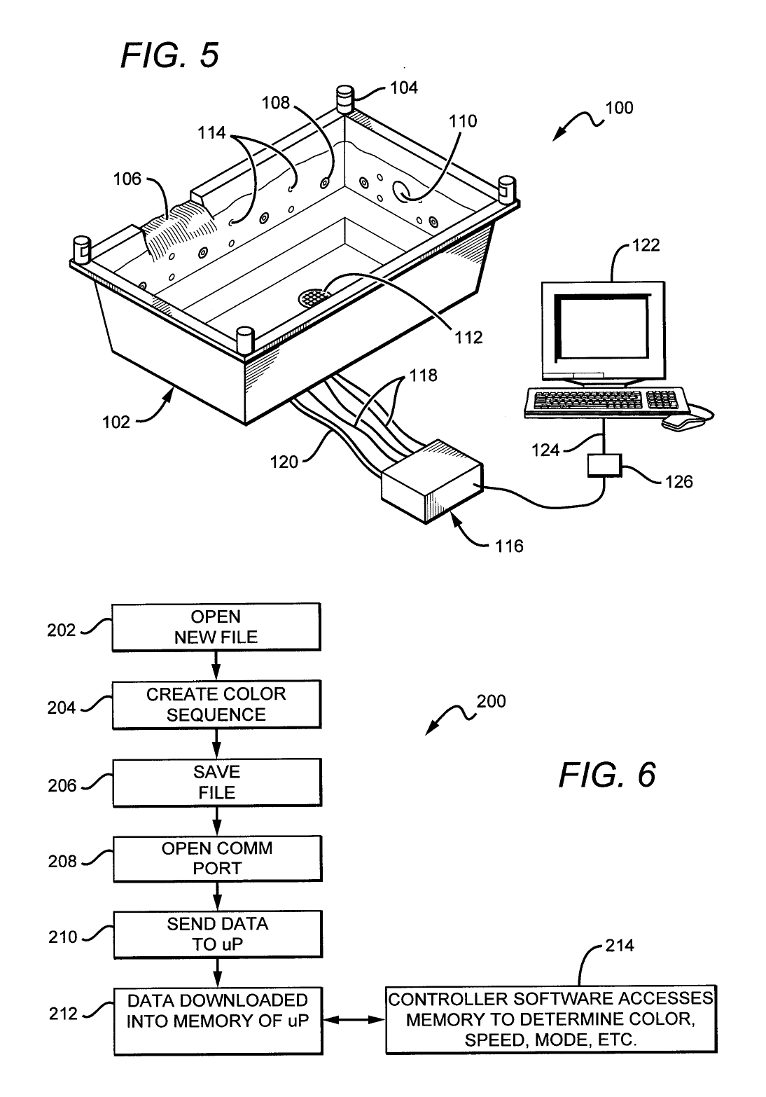

FIG. 5 shows one embodiment of a spa 100 utilizing a lighting system according to the present invention. The spa 100 comprises a shell or reservior 102 for holding water and a plurality of spa components, some or all of which can comprise a lighting element such as one or more LEDs. The components can include spa speakers 104, waterfalls 106, jets 108, flood lights 110, drains 112 and point lights 114. The spa also comprises a lighting system 116 according to the present invention that can be programmed to control the lights in the spa 100 with lighting characteristics as described above. The system 116 can be mounted internal to the spa, such as behind the spa's skirt, or it can be mounted external to the spa. The LEDs from the different components can be divided into zones with each of the zones connected to the system 116 along a respective one of the conductive cables 118. In the embodiment shown, there are four cables representing four different zones as described above, but it is understood that the system 66 can also drive more of fewer zones.

A power cable 120 can be provided that runs from one of the spa's internal components to provide power to the system 116. In this embodiment the power cable can run from the spa's internal spa controller to the system 116. The cable 120 can also carry a switch signal that signals the system 116 to switch between one of its seven modes. As mentioned above, different embodiments can have different numbers of modes, some of which can be fewer or more than seven.

A PC 122 can be included that programs the system 116 with the desired user lighting effects. The data and system program can be transmitted along cable 124 to the system 116. In one embodiment that communication takes place from one of the PC's USB ports and the cable 124 comprises a USB cable. The communication between the PC 122 and the system 116 can take place through a USB-dongle 126 as described above.

The system 116 can be programmed by the user so that the zones have the desired lighting effect. The zones can be programmed to operate separately or cooperation as described above.

The present invention is also directed to different methods of providing lighting effects for a spa. FIG. 6 shows one embodiment of a method 200 for programming a spa lighting system to provide spa lighting effects. In step 202 a file is opened for the custom lighting effect data, and in one embodiment this can be the opening of a file on a PC as described above. In 204 the data for the color sequences for the spa lighting can be created. In some embodiments this can comprise creating the color effects for the different zones in the modes as described above. In 206 the custom effect data file is saved such as by saving on a PC as described above. One the data file is created it should be transmitted to the controller for the lighting system.

In 208 a communication port is to the controller such as by opening a communication port on the PC. In 210 the data can be transmitted through the opened communication port to the microprocessor in the controller. This can be done over through a USB port and over a USB cable as described above. In 212 the data can be loaded into microprocessor memory. In 214 the controller software/firmware accesses data in memory to determine the particular emission characteristics for the different zones. This can include the characteristics described above, such as color, speed, mode, etc.

Although the present invention has been described in considerable detail with reference to certain preferred configurations and methods, other versions are possible. Therefore, the spirit and scope of the appended claims should not be limited to the preferred versions described above.

I claim:

1. A system for controlling lighting in a pool/spa, comprising:
a controller; and
a plurality of light sources arranged in said pool/spa at least some of said light sources illuminating the interior of said spa, said light sources divided into a plurality of lighting zones, wherein said controller controls to illumination of said lighting zones to create different pool/spa lighting effects.

2. The system of claim 1, wherein said controller comprises a microprocessor.

3. The system of claim 1, wherein at least one of said lighting zones comprises a plurality of light emitting diodes (LEDs).

4. The system of claim 3, wherein said LEDs are connected in a daisy-chain.

5. The system of claim 3, wherein said LEDs are serially interconnected.

6. The system of claim 3, wherein said LEDs are connected in parallel.

7. The system of claim 3, wherein said LEDs are interconnected in a series and parallel interconnect combination.

8. The system of claim 1, wherein one of said lighting zones comprises one of a flood light, light sources on spa skirt, water feature lights, and spa speaker lights.

9. The system of claim 1, wherein said controller is programmed by a computer.

10. The system of claim 9, wherein said controller comprises a memory to store a program from said controller.

11. The system of claim 1, wherein at least some of said light sources comprise red, green and blue (RGB) emitters.

12. The system of claim 1, wherein said pool/spa lighting effects comprises one of color wheel, color jump, color extract, and color flow.

13. The system of claim 1, wherein said color effects comprise a plurality of different color effects, said system further comprising a mechanism for switching between said plurality of color effects.

14. A method for controlling the lighting in a pool/spa, comprising:
providing a pool/spa with light sources arranged in zones;
creating color effect data from a computer, with said color effect data controlling the illumination of said lighting zones; and
storing said color effect data at said pool/spa to produce different pool/spa lighting effects.

15. The method of claim 14, wherein said pool/spa comprises a controller utilizing said color effect to cause said lighting effects.

16. The method of claim 15, wherein said controller comprises a microprocessor.

17. The method of claim 15, wherein said controller comprises memory.

18. The method of claim 14, wherein said color effect date is generated on a computer through a user interface.

19. The method of claim 14, wherein said color effect data comprise a plurality of color effects.

20. The method of claim 19, further comprising switching between different ones of said color effects.

21. The method of claim 14, wherein said lighting effects comprises one or more of color wheel, color jump, color extract, and color flow.

22. A system for controlling lighting, comprising:
a controller having a microprocessor and memory; and
a plurality of light sources light sources coupled to said microprocessor, wherein said light sources are divided into a plurality of lighting zones, and wherein said memory contains a color effect program executable by said microprocessor to control the illumination of said lighting zones to create different lighting effects.

23. The system of claim 22, further comprising a remote computer generating said color effect program and storing said color effect data in said memory.

24. The system of claim 22, wherein said color effect program is executable my said microprocessor to generate a plurality of color effects.

25. The system of claim 24, further a switching device to switch between different ones of said plurality of color effects.

26. The system of claim 22, wherein said plurality of lighting effects one or more of color wheel, color jump, color extract, and color flow.
